(19) United States
(12) Patent Application Publication
(10) Pub. No.: US 2012/0090564 A1
(43) Pub. Date: Apr. 19, 2012

(54) HYDROGEN GAS ENGINE AND ENERGY-SAVING AUTOMOBILE

(76) Inventor: Takuya OGAWA, Tokyo (JP)

(21) Appl. No.: 12/971,775

(22) Filed: Dec. 17, 2010

(30) Foreign Application Priority Data
Oct. 13, 2010 (JP) 2010-230533

(51) Int. Cl. F02B 43/08

(52) U.S. Cl. 123/3

(57) ABSTRACT

Compressor 107 which compresses the supplied air, burner 102 which mixes the compressed air compressed by compressor 107, and fuel gas, and burns the mixed gas, turbine 106 which generates driving force using the expansion force at the time of combustion of the fuel gas in burner 102, and compressed air, gas generation equipment 101 made to generate hydrogen gas and oxygen gas by electrolyzing water, gas generation equipment 101 is connected through the distribution unit 200 or directly to burner 102, and it has transfer pipe 113 supplied to a burner by making hydrogen gas and oxygen gas into fuel gas, compressor 107 compresses air with the power generated in turbine 106.

### TECHNICAL FIELD

The present invention relates to a hydrogen gas engine which uses a hydrogen gas and an oxygen gas as a fuel gas, and an energy-saving automobile mount the engine.

### BACKGROUND ART

These years, Environmental problems, such as global warming, occur, about the automobile, the increase in efficiency of fuel consumption and purification of exhaust gas are tried. However, the limit of the improvement has come about in the automobile provided only with the internal-combustion engine which uses a fossil fuel. Now, in the present, the hybrid car provided with two motors, an internal-combustion engine and an electric motor, is developed and put in practical use (for example, patent documents 1)
Patent Document 1: Japanese Patent Published Application No. 2005-020911,A

### DISCLOSURE OF THE INVENTION

However, about the hybrid car indicated with patent documents 1, discharge of air pollution gas is suppressed rather than the automobile which uses only a fossil fuel for fuel. While, in the hybrid car, running according to an internal-combustion engine has become still main, since gasoline is used as the fuel, air pollutants, such as carbon dioxide, are discharged.

Then, taking into consideration the above circumstances, it is an object of the present invention to provide a hydrogen gas engine and energy-saving automobile which can suppress discharge of greenhouse gases without using a fossil fuel

In order to accomplish the object as described above, in accordance with the present invention, which a hydrogen gas engine comprising:

a compressor configured to compress the supplied air;

a burner configured to burn the mixed gas of the compressed air by the compressor, and fuel gas;

a driving unit configured to generate power using the expansion force by combustion of the mixed gas in the burner;

a gas generation equipment configured to generate hydrogen gas and oxygen gas by electrolyzing water; and

a fuel gas supplying means configured to connect the gas generation equipment to the burner directly, and to supply the hydrogen gas and oxygen gas to the burner as the fuel gas,

wherein the compression means compresses air with the power generated in the driving unit.

In the above invention, as for the hydrogen gas engine wherein the driving unit is a turbine which rotates using the expansion force by combustion of the mixed gas.

In the above invention, as for the hydrogen gas engine, wherein the burner and the compressor are combustion chambers formed in a sealed cylinder by the cylinder and this piston that moves up and down in the cylinder, the driving unit is the piston which moves up and down using a expansion force by combustion of the mixed gas.

According to this invention, hydrogen gas and oxygen gas are generated from water with a gas generation equipment; the hydrogen gas and oxygen gas are used as fuel gas of a power engine. Accordingly, because the fuel for the power engine is water and electricity, fuel is cheap, they can be got easily and it gets economical. Therefore, compared with a fossil fuel like gasoline, cost is greatly reduced. Because hydrogen gas and oxygen gas change to water after combustion, they are pollution-free, no polluting, and avirulence, and can realize clean combustion which does not pollute environment.

As for the fuel gas supplying means, in the above invention, it is preferred to generate a flame using the generating gas from the gas generation equipment, and to supply the flame to the burner. In this case, since the apparatus for generating a flame becomes unnecessary, parts are decreased and a apparatus can be miniaturized.

As for the burner, in the above invention, it is preferred to generate a flame by a part of generating gas from the gas generation equipment, to mix the flame with the remaining generating gas, and to burn the compressed air. In this case, combustion with a burner can be stimulated by supplying the flame generated from the gas generation equipment to a burner.

In the above invention, it has even a photovoltaic power generation unit including solar cell which generates electric power by light-receiving, as for the gas generation equipment, it is preferred to take electric power required for the electrolysis from the photovoltaic power generation unit. In this case, because a gas generation equipment is driven with the electric power taken from light energy, the clean combustion which does not pollute environment is realizable.

In the above invention, it has even an aerogenerator generates electric power with wind force, as for the gas generation equipment, it is preferred to take electric power required for the electrolysis from the aerogenerator. In this case, because the gas generation equipment is driven with the electric power taken from wind force, the clean combustion which does not pollute environment is realizable.

Other inventions are energy-saving automobiles which run with the hydrogen gas engine of the above invention. According to this invention, the energy-saving automobile which suppresses discharge of greenhouse gases can be provided, without using a fossil fuel.

### EFFECT OF THE INVENTION

According to the above invention, discharge of greenhouse gases can be suppressed, without using a fossil fuel.

### BRIEF DESCRIPTION OF THE DRAWINGS

FIG. 1 is an outline view of the energy-saving automobile 1 related to the embodiment.

FIG. 2 is a block diagram showing an internal structure of the energy-saving automobile 1 carrying the hydrogen gas turbine engine 10 related to the embodiment.

FIG. 3 (a) is a sectional view showing an internal structure of the distribution unit 200 of an embodiment, and FIG. 3 (b) is an A-A sectional view in (a).

FIG. 4 is a flow chart which shows operation of the hydrogen gas turbine engine 10 related to the embodiment.

FIG. 5 is a flow chart which shows operation of the distribution unit 200 related to an embodiment.

FIG. 6 is a sectional view showing operation of the distribution unit 200 related to an embodiment (in cases where supplying all gas).

FIG. 7 is a sectional view showing operation of the distribution unit 200 related to an embodiment (in cases where supplying a flame).

FIG. 8 is a sectional view showing operation of the distribution unit 200 related to an embodiment (in cases where distributing a portion of gas).

FIG. 9 is a block diagram showing an internal structure of the automobile 1 which mounts a four cycle engine related to a modified example.

### DESCRIPTION OF THE PREFERRED EMBODIMENTS

(Structure of the Hydrogen Gas Turbine Engine 10)

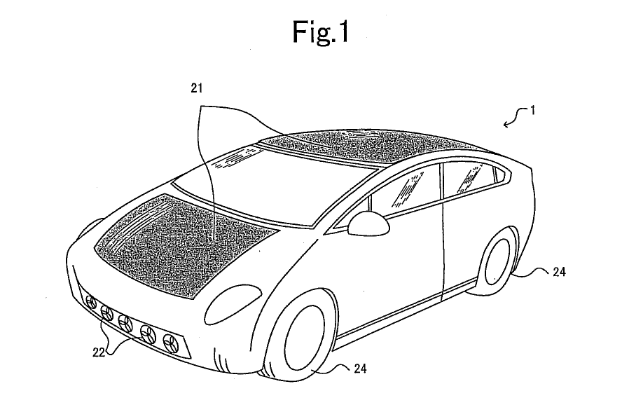

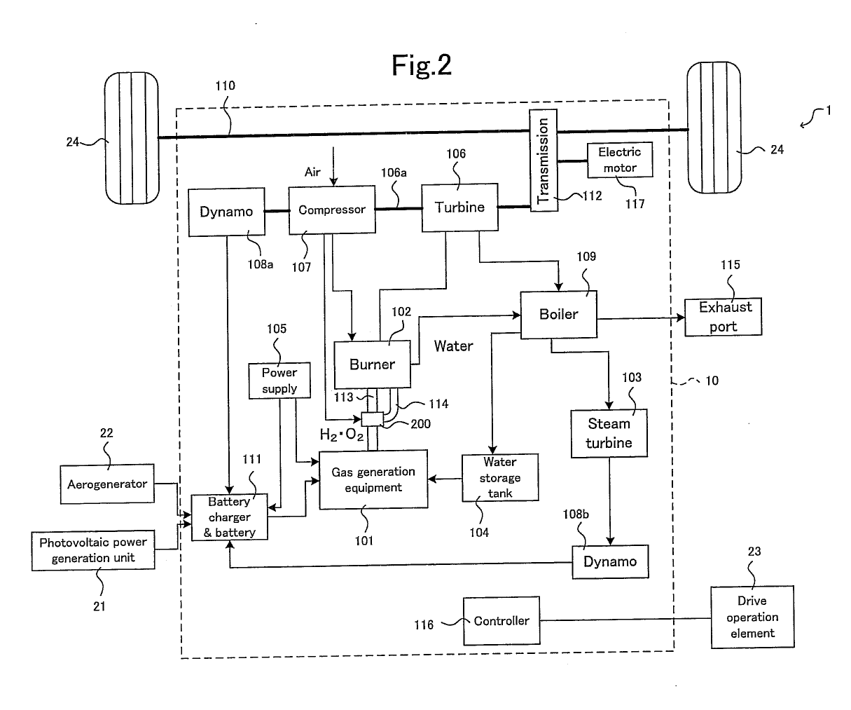

An embodiment of the present invention will be explained with reference to the accompanying drawings. The embodiment explains a hydrogen gas turbine engine which used a turbine rotates using a expansion force by combustion of a mixed gas as a driving unit. FIG. 1 is an outline view of an energy-saving automobile which mounts a hydrogen gas turbine engine related to the present invention as a hydrogen gas engine, and FIG. 2 is a block diagram showing the internal structure. In this embodiment, as an example of the present invention, the energy-saving automobile it runs with a hydrogen gas engine is explained.

Although explained as an example, a case where a hydrogen gas turbine engine related to the present invention is mounted in an automobile in this embodiment, the scope of the present invention is not limited in that case, and a hydrogen gas turbine engine of this invention can be applied to other means of transportation, such as an airplane and a marine vessel, for example.

As shown in FIG. 2, the hydrogen gas turbine engine 10 of the energy-saving automobile is mainly provided with a gas generation equipment 101 and a burner 102, and has a turbine 106, a compressor 107, and a dynamo 108 which were connected with one shaft.

The gas generation equipment 101 is a apparatus which generates a hydrogen gas and an oxygen gas by electrolyzing a water, a water as fuel is supplied from a water storage tank 104, electrolyzes a water using electric power from a power supply 105 or a battery charger and battery 111.

The principle of operation of this apparatus, alternating current is temporarily changed into a direct current, and each current is inputted into an anode plate and the cathode. And in an electrolytic cell, in which the two poles were inserted, water is electrolyzed and a hydrogen gas and an oxygen gas are generated as a fuel gas. Distilled water or soft water can be used as the water, by gathering the electric energy from the power supply, the mixed gas of hydrogen gas and oxygen gas is emitted. A pressure of this generating gas can adjust an output of the generating gas by being automatically controlled by a pressure switch and a controller and going via a flow regulator by them.

The burner 102 is connected to the gas generation equipment 101 by a transfer pipe 113. This transfer pipe 113 is a fuel gas supplying means for supplying generating gas to a burner 102 as a fuel gas. Thus, a hydrogen gas and an oxygen gas which were generated from the gas generation equipment 101 are supplied to the burner 102 through the transfer pipe 113 as a fuel gas.

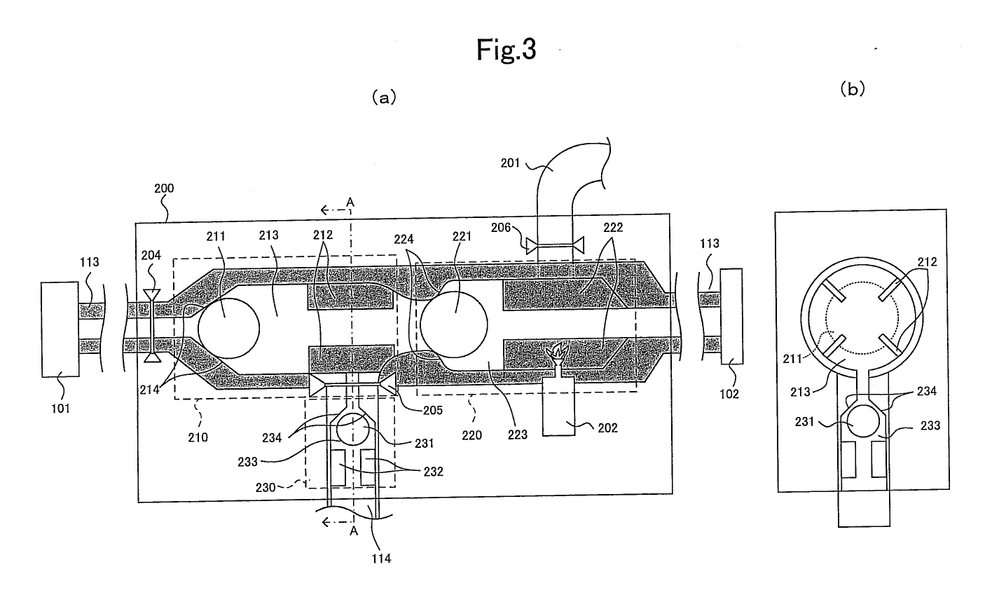

The transfer pipe 113 is provided with a distribution unit 200 as a function to generate a flame oneself, using the fuel gas. As shown in FIG. 3, this distribution unit 200 comprises an ignition device 202 which ignites a fuel gas, a nonreturn valve unit 210 which stops an adverse current of a generated flame, a flame thrower 220 which jets the flame, and a branching unit 230 which branches a portion of fuel gas.

The nonreturn valve unit 210 comprises a bulb 204 which opens and closes a course from the gas generation equipment 101, a internal space 213 through which a fuel gas goes, and a ball 211 which moves in a space 213.

In the internal space 213, taper 214 and blades 212 which restricts migration of the ball 211 are constructed. The taper 214 is a shape which stops the ball 211 which moves in the gas generation equipment 101 direction, when a pressure of the internal space 213 gets high, taper 214 should be closed with the ball 211, the ball 211 stops that a gas in the internal space 213 flows in reverse to the gas generation equipment 101.

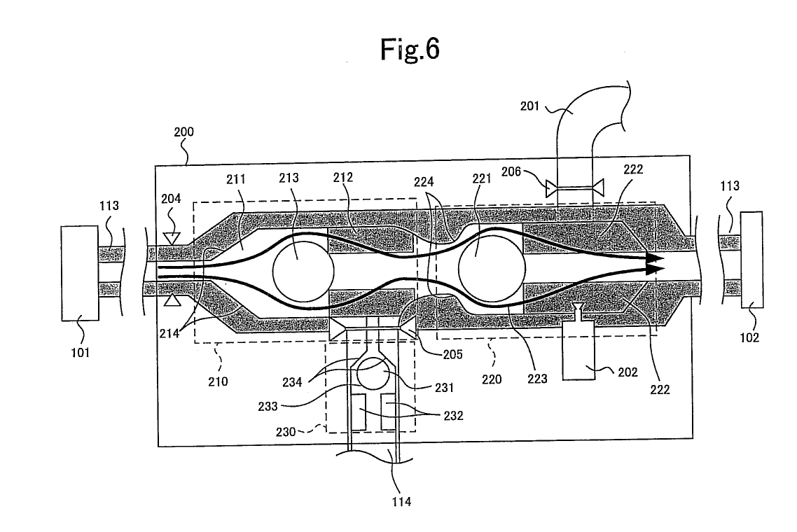

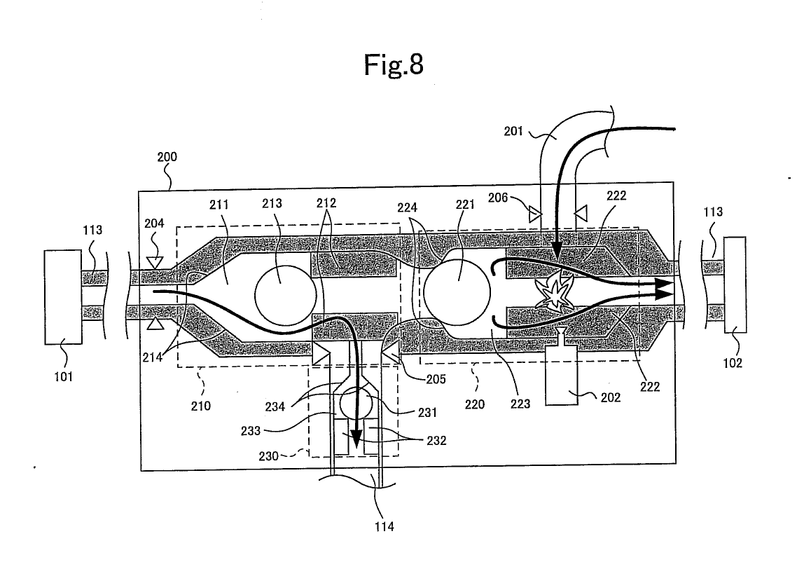

The blades 212 of the opposite side are four flanges which stop the ball 211 which moves to the flame thrower 220 of a downstream direction, even though the blade 212 stops the ball 211 when pressure of the internal space 213 gets low as shown in FIG. 6, a clearance between the blades 212 and 212 serves as a flow path of a gas, and a flow to the flame thrower 220 of a gas is not stopped. If the bulb 205 of the branching unit 230 is then opened as shown in FIG. 8, a portion of gas will flow into a transfer pipe 114 side.

The branching unit 230 comprises a bulb 205 which opens and closes a course from the nonreturn valve unit 210, a internal space 233 through which a fuel gas goes, and a ball 231 which moves in the space 233.

In the internal space 233, taper 234 and blades 232 which restricts migration of the ball 231 are constructed. The taper 234 should be a shape which stops the ball 231 which moves to an internal space 213 side, and when pressure of the internal space 233 gets high, the taper 234 should be closed with the ball 231, the ball 231 stops that a gas in the internal space 233 reverts to an internal space 213 side.

The blade 232 of the opposite side is a flange which stops the ball 231 which moves to a downstream direction, even though the blade 232 stops the ball 231 when pressure of the internal space 233 gets low (when pressure of the internal space 213 gets high), a clearance between the blade 232 and 232 serves as a flow path of a gas, and a flow to the transfer pipe 214 of a gas is not stopped.

The flame thrower 220 comprises an internal space 223 through which a fuel gas from the internal space 213 goes, and a ball 221 which moves in an internal space 223. The ignition device 202 which ignites a fuel gas is located, and the conduit 201 from the compressor 107 is connected to the internal space 223. In the internal space 223, taper 224 and the blade 222 which restricts migration of the ball 221 are constructed.

The tapers 224 are shape which stops the ball 221 which moves in the internal space 213 direction, and when a pressure of the internal space 223 gets high, taper 224 should be closed with the ball 221, the ball 221 stops that a gas in the internal space 223 flows in reverse to the internal space 213.

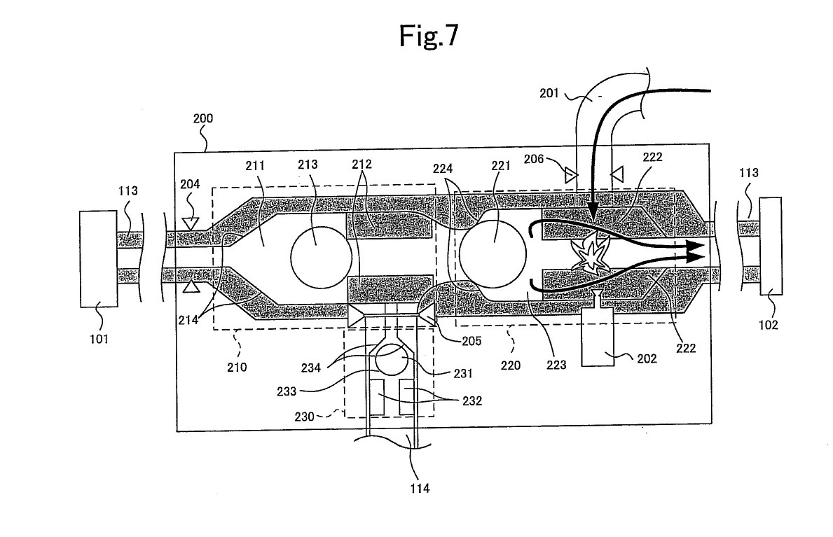

In the flame thrower 220, a part of compressed air of the compressor 107 is used as pressure which jets the flame. Thus, in order to increase a pressure of this internal space 223, the bulb 206 of the conduit 201 is opened and compressed air is blown into the internal space 223. The ball 221 is pushed on the taper 224 by blowing compressed air. And as shown in FIG. 7, when a pressure of the internal space 223 gets high, if the ignition device 202 ignites the gas, a generated flame will flow into the burner 102 side.

The blade 222 of the opposite side is a flange which stops the ball 221 which moves to a downstream direction, even though the blade 222 stops the ball 221 when pressure of the internal space 223 gets low as shown in FIG. 6, a clearance between the blade 222 and 222 serves as a flow path of a gas, and a flow to the burner 102 of a gas is not stopped.

The transfer pipe 113 as a fuel gas supplying means is provided also with a function to generate a flame by a portion or the whole of a fuel gas (generating gas) from the gas generation equipment 101. In detail, the bulb 234 of the branching unit 230 is closed, in cases where all of generating gas from the gas generation equipment 101 are seen out to the flame thrower 220, in the flame thrower 220, a flame is generated by whole of generating gas.

In cases where a portion of fuel gas from the gas generation equipment 101 is bowed out from the branching unit 230 to the flame thrower 220, in the flame thrower 220, a flame is generated by a portion of generating gas, the remaining fuel gas is supplied to the burner 102 through the transfer pipe 114 which is different in the transfer pipe 113.

And the burner 102 mixes compressed air to a flame and the remaining fuel gas, and burns them. Thus, combustion in the burner 102 can be stimulated by supplying a flame from the distribution unit 200 to the burner 102.

According to the above mechanism, the distribution unit 200 can control volume and balance of a fuel gas and a flame which are supplied to the burner 102. Accordingly, the distribution unit 200 can inject only a gas from the gas generation equipment 101 to the burner 102 directly, without adding a flame, and, moreover, the distribution unit 200 can generate a flame using a portion or the whole of a fuel gas, and can inject it to the burner 102. At this time, temperature of a flame can also be suitably controlled by letting a gas before being ignited pass in temperature fall liquid.

Even though it is not illustrated, it is good also as composition which connects gas generation equipment 101 and burner 102 directly, unifies them, and omits transfer pipes 113 and 114 and distribution unit 200.

Compressor 107 is a apparatus which compresses air, compresses the air intake from the outside, supplies hot and high-pressure compressed air to burner 102. Compressor 107 is connected to the same shaft as turbine 106, It compresses air on the torque in turbine 106.

The burner 102 is a apparatus which burns a mixed gas of compressed air by the compressor 107, and a fuel gas, and supplies a burned combustion gas to the turbine 106. By a drain, a condenser, etc., a water generated by combustion of a hydrogen gas and an oxygen gas is exhausted from the burner 102, and is supplied to the boiler 109.

The turbine 106 is gas turbine equipment generate power using expansion force by combustion of a mixed gas in the burner 102. Concretely, in turbine 106, by throwing the fuel gas which burned and expanded at an impeller, the thermal energy is converted into rotational kinetic energy, and power is generated. And as for this embodiment, his generated power is delivered by both dynamo 108a and wheels 24, thereby, electric power is generated or wheels 24 is rotated.

In detail, the turbine 106 is connected with transmission 112 by turbine shaft 106a, an axle 110 which connects wheels 24 and 24 is connected to transmission 112. And the power is delivered to the transmission 112 by the turbine shaft 106a because the turbine 106 rotates. And with the transmission 112, rotational frequency, speed, torque, etc. are changed, power is delivered to the axle 110, the wheels 24 and 24 connected with the wheel 110 rotate, and an automobile runs.

The electric motor 117 is connected to the transmission 112 as auxiliary power, and the axle 110 is rotated also with a power from the electric motor 117. Accordingly, the transmission 112 can deliver selectively either a power from the turbine 106, or a power from the electric motor 117 to the axle 110, or it can deliver those both to the axle 110 simultaneously. The transmission 112 adjusts a rotational frequency of these two powers, speed, and torque then. An electric power to the electric motor 117 is supplied from the power supply 105, a battery charger and the battery 111, and the dynamos 108a and 108b. Thus, an initial time lag by a starting delay at the time of a start-up of a hydrogen and oxygen gas generating, etc. is settled by using a power of the electric motor 117 together auxiliary.

On the other hand, the dynamo 108a connected to the same shaft as the turbine 106 rotates, and the rotation generates electricity because the turbine 106 rotates by combustion of a fuel gas. And generated electric power is supplied to the battery charger and battery 111. In the embodiment, a combustion gas exhausted from the turbine 106 is supplied to the boiler 109.

The boiler 109 is a apparatus which generates a process steam with a fuel gas. In detail, as for this embodiment, the fuel gas exhausted from turbine 106 is supplied to boiler 109, in the boiler, process steam is generated by the water and heat exchange from burner 102, this process steam is supplied to the steam turbine 103. The boiler 109 is connected with the exhaust port 115, and a process steam which is not supplied to the steam turbine 103 is made to exhaust from the exhaust port 115.

The steam turbine 103 is a apparatus made to generate kinetic energy with a process steam from the boiler 109. Concretely, in the dynamo 108b, an impeller is located in a position which a process steam of the boiler 109 passes, and kinetic energy is gotten by rotating the impeller with a process steam. And in the embodiment, the dynamo 108b is connected to a revolving shaft of this turbine (impeller), and the dynamo 108b generates electricity by rotation of this turbine. This dynamo 108b is also connected with the battery charger and battery 111, and generated electric power is supplied to the charge machine 111.

In the embodiment, a photovoltaic power generation unit 21 which generates electric power by light-receiving and solar cells, and an aerogenerator 22 which generates electric power with wind force are provided. According to the embodiment, electric power from the photovoltaic power generation unit 21 and the aerogenerator 22 is stored with the battery charger and battery 111, from the battery charger and battery 111, electric power is supplied to the gas generation equipment 101, and it is considered as electric power of electrolysis in the gas generation equipment 101.

The battery charger and battery 111 is a battery which stores electric power from the dynamos 108a and 108b, the photovoltaic power generation unit 21, and the aerogenerator 22, and storage batteries, such as a lithium manganese cell, lithium ion electrical machinery, a nickel-cadmium battery, and a nickel hydride battery, can be used for it. Thus, dump power can be used for the electrolysis of water, combustion of a combustion gas, etc. by storing electric power to the battery charger and battery 111. The external power supply 105 is connected to this battery charger and battery 111, and charge of the battery is possible also by an electric power supply from the power supply 105. This power supply 105 is a contact button to a home electric socket and an electric power supply plug of a charging stand (charge spot), may also be other batteries.

The controller 116 is CPU which controls the whole about a drive of an automobile, controls a driving signal of each apparatus, such as the amount of supply of electricity and water to the gas generation equipment 101, adjustment of gas pressure and fire temperature which are required in the turbine 106, adjustment of the transmission 112, corresponding to operation by the drive operation element 23 (an accelerator, a handle, etc.).

Even though it used the singular gas generation equipment about the hydrogen gas engine in this embodiment, a plurality of gas generation equipment can also be arranged in parallel and located, for example.

(Operation of the Hydrogen Gas Engine)

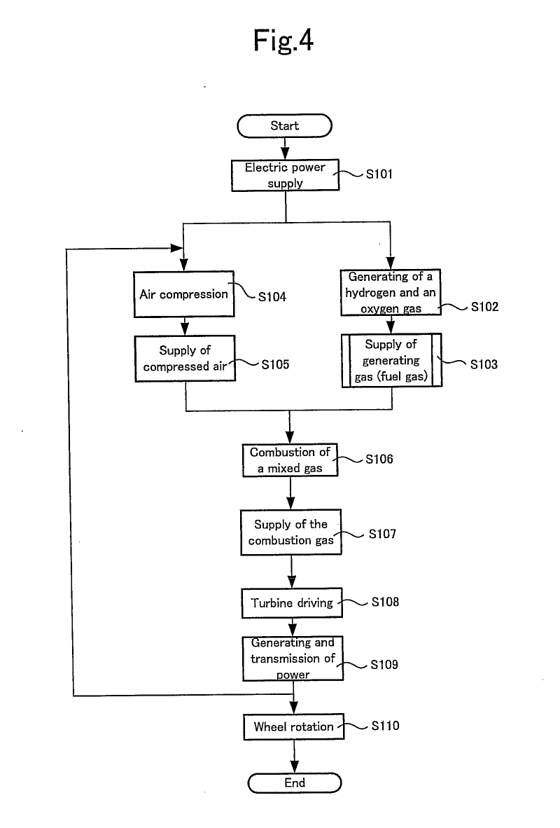

And it is made to run the automobile 1 by driving the wheel 24 with such a hydrogen gas engine in the embodiment. FIG. 4 is a flow chart which shows a step of a method for driving the energy-saving automobile 1 with a hydrogen gas engine.

Accordingly, a water from the water storage tank 104 and electric power from the battery charger and battery 111 are supplied to the gas generation equipment 101 because a driver steps in an accelerator (Step S101). In the gas generation equipment 101, the water is electrolyzed and a fuel gas is generated (Step S102). And this fuel gas is supplied to the burner 102 (Step S103). In this case, in the compressor 107, an air is inhaled from the exterior, the air is compressed, and compressed air is supplied to the burner 102 (Steps S104 and S105).

In the burner 102, a supplied fuel gas and compressed air are mixed, a mixed gas is burned inside the burner 102 (Step S106), and this gas that burned is supplied to the turbine 106 (Step S107). In the turbine 106, with expansion force of this combustion gas, a turbine (impeller) is rotated (Step S108) and power is generated (Step S109). Thereby, the axle 110 rotates by the transmission 112 connected to the shaft 106a of this turbine, the wheel 24 joined with both sides of the axle 110 rotates, and the energy-saving automobile 1 runs (Step S110).

On this occasion, the control part 116 performs simultaneously adjustment of the yield of hydrogen gas in the gas generation equipment 101, and oxygen gas, the amount of combustion of the fuel gas in the burner 102, and the transmission 112 etc. according to operation of the drive operation element 23 (an accelerator, a handle, etc.). As mentioned above, the burner 102 is connected to the gas generation equipment 101 by the transfer pipe 113, a hydrogen gas and an oxygen gas which were generated from the gas generation equipment 101 are supplied to the burner 102 through the transfer pipe 113.

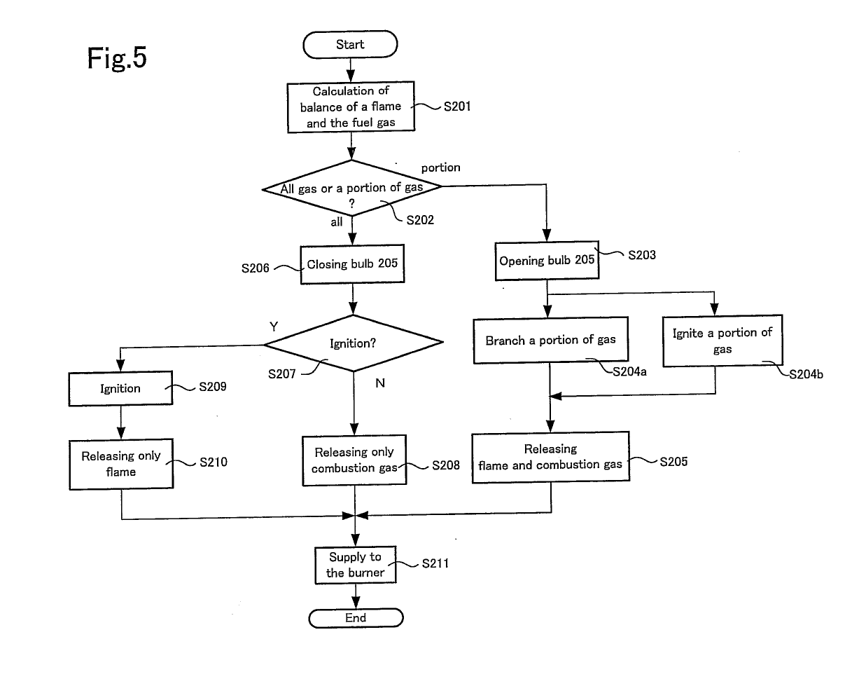

The transfer pipe 113 is equipped with the distribution unit 200 which has a function to branch a portion of fuel gas, and a function to generate a flame using a portion or the whole of a fuel gas. In Step S102, the controller 116 controls the distribution unit 200 as follows to be shown in FIG. 5 in detail.

First, the controller 116 computes required volume of a fuel gas and a flame, computes these balance (Step S201), and determines opening quantity of the bulb 205, and necessity of ignition based on this calculating result.

Next, the controller 116 judges whether the whole of a fuel gas is supplied to the burner 102, or it branches in a portion of generating gas (Step S202). In cases where it branches a portion of fuel gas and supplies the burner 102, the bulb 205 is opened by required volume (Step S203). When a hydrogen gas and an oxygen gas which were generated from the gas generation equipment 101 are thereby supplied to the distribution unit 200 through the transfer pipe 113, as shown in FIG. 8, a portion of the generating gas branches to the transfer pipe 114 side, the branched gas is directly supplied to the burner 102 (Step S204a).

The remaining part of the fuel gas is supplied to the internal space 223 of the transfer pipe 113, and is ignited (Step S204b). As a result, both a flame and a fuel gas are supplied to the burner 102 (Steps S205 and S11).

On the other hand, in cases where it supplies the whole of a fuel gas to the burner 102, the bulb 205 is closed fully (Step S206). And the controller 116 judges whether ignites or not according to determination in Step S201 (Step S207). In cases where ignition is unnecessary, it is (Step S207:N), as shown in FIG. 6, a fuel gas goes through the internal space 223, without being ignited. As a result, only a fuel gas is directly supplied to the burner 102 (Steps S208 and S11).

On the other side, in cases where ignition is required, it is (Step S207:Y), as shown in FIG. 7, a fuel gas is ignited in the internal space 223 (Step S209). As a result, only a flame is supplied to the burner 102 (Steps S210 and S11).

### EFFECT OF THE INVENTION

According to the above embodiment, since hydrogen gas and oxygen gas are generated from water and those gas is used as fuel gas of a power engine with the gas generation equipment 101, the materials used as fuel are only water and a general power supply, and fueling cost is cheap. Accordingly, because the fuel for the power engine is water and electricity, fuel is cheap, they can be gotten easily and it gets economical. Therefore, compared with a fossil fuel like gasoline, cost is greatly reduced. Since hydrogen gas and oxygen gas change to water after combustion, they are pollution-free, no polluting, and avirulence, and can realize clean combustion which does not pollute environment.

According to this embodiment, since a flame is itself generated using the gas emitted with gas generation equipment 101 and the flame is supplied to burner 102, the apparatus made to generate a flame cannot be produced and located and a whole reduction and apparatus of part mark can be miniaturized.

In this embodiment, a flame is generated by a part of generating gas generated from the gas generation equipment 101, the flame is mixed with compressed air with the remaining generating gas, and it can burn. The flame generated from the gas generation equipment 101 can be supplied to the burner 102 thereby, and combustion with burner 102 can be stimulated.

According to this embodiment, it has the photovoltaic power generation unit 21 or the aerogenerator 22 even, since electric power required of the electrolysis in gas generation equipment 101 is supplied from these dynamos, gas generation equipment 101 can be made to drive with light energy or the electric power generated from wind force. As a result, the clean combustion which does not pollute environment with pollution-free, no polluting, and avirulence is realizable.

(Modification)

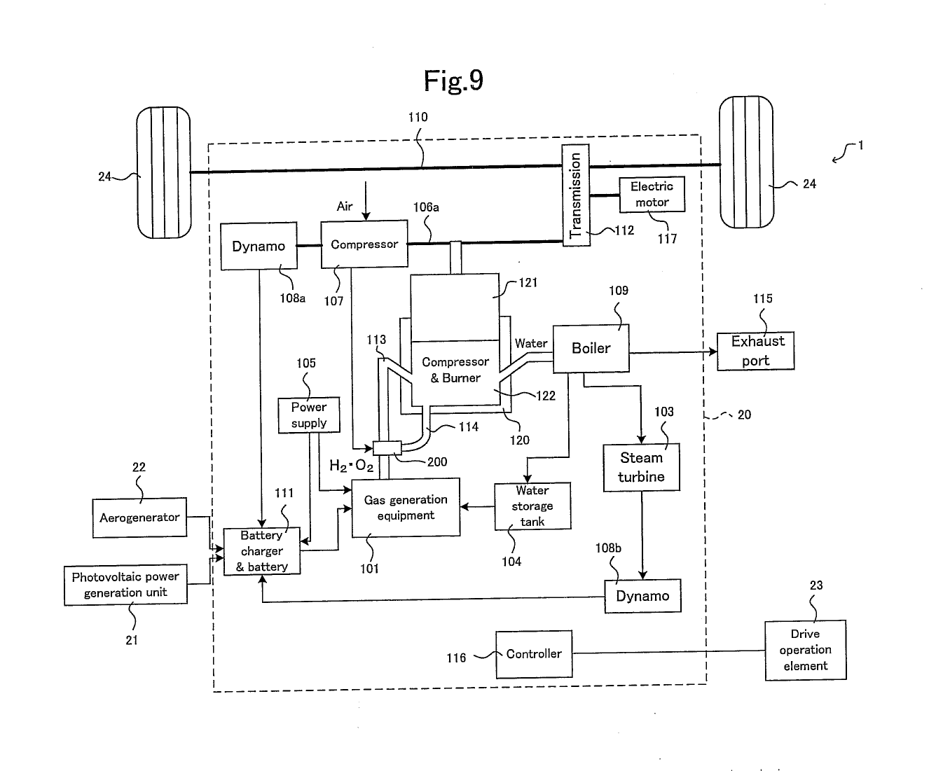

Although a hydrogen gas turbine engine using a turbine which rotates using a expansion force by combustion of a mixed gas as a driving unit was explained to an example in the above embodiment, The present invention is not limited to the style, the present invention is applicable to a structure of a ordinary four cycle engine or two cycle engines as it is. FIG. 9 is a block diagram showing an example which applied the present invention to a general four cycle engine.

Accordingly, in this modification, the combustion chamber 122 in a hydrogen gas engine 20 formed in the cylinder 120 is used as the burner and the compressor. The combustion chamber 122 is formed by the cylinder 120 which has a bottom and was sealed, and the piston 121 which moves up and down within this cylinder 120. In this case, the piston 121 which moves up and down using the expansion force by combustion of a mixed gas is the driving unit of the present invention. The gas generation equipment 101 is connected to the combustion chamber 122 by the transfer pipes 113 and 114. The transfer pipe 113 supplies a hydrogen gas and an oxygen gas which were generated from the gas generation equipment 101 to the combustion chamber 122 as a fuel gas.

In the combustion chamber 122, a mixed gas of a compressed air compressed by the piston 121 and a fuel gas burns, the piston 121 is driven with a expansion force by combustion. By a drain, a condenser, etc., water generated by combustion of a hydrogen gas and an oxygen gas is exhausted from the combustion chamber 122, and is supplied to the boiler 109.

In this case, the compressor 107 generates a compressed air for jetting a gas and a flame from the distribution unit 200 to the combustion chamber 122, and it is supplied to the distribution unit 200.

As for the hydrogen gas engine 20, a fuel gas and an air are inhaled by a upswing of the piston 121, the mixed gas is compressed by a downturn of the piston 121, the compressed mixed gas is ignited and burns, and a gas and water after combustion are exhausted.

A power generated by an up-and-down motion of the piston 121 is delivered to both the dynamo 108a and the wheel 24, thereby, generates electric power or rotates the wheel 24. In detail, the piston 121 is connected with the transmission 112 by the shaft 106a, and the axle 110 which connects the wheels 24 and 24 is connected to the transmission 112. The power is delivered to the transmission 112 by the shaft 106a because the piston 121 moves up and down. And with the transmission 112, rotational frequency, speed, torque, etc. are changed, power is delivered to the axle 110, the wheels 24 and 24 connected with the wheel 110 rotate, and an automobile runs.

A rotary engine can be selected as other embodiments of the above hydrogen gas engine, for example. In detail, a combustion chamber formed in rotor housing is used as the burner and the compressor. The combustion chamber is formed by a rotor housing shaped with peritrochoid curves, and a triangle rotor rotated within this rotor housing. In this case, the rotor rotated using a expansion force by combustion of a mixed gas is a driving unit of the present invention.

As for the hydrogen gas engine related to such the modification, like the embodiment mentioned above, a hydrogen gas and an oxygen gas are generated from water, and that gas is used as a fuel gas of a power engine. Thereby, fueling cost can be reduced and clean combustion which does not pollute environment with pollution-free, no polluting, and avirulence can be realized. And according to the modification, without changing a structure of an existing automobile substantially, because the same structure as an existing gasoline engine can be used, the present invention can be applied and a manufacturing cost can be reduced.

### DESCRIPTION OF NOTATIONS

10—Hydrogen gas turbine engine
20—Hydrogen gas engine
21—Photovoltaic power generation unit
22—Aerogenerator
23—Drive operation element
24—Wheel
101—Gas generation equipment
102—Burner
103—Steam turbine
104—Water storage tank
105—Power supply
106—Turbine
106a—Turbine shaft
107—Compressor
108a, 108b—Dynamo
109—Boiler
110—Axle
111—Battery charger and battery
112—Transmission
113—Transfer pipe
114—Transfer pipe
115—Exhaust port
116—Controller
117—Electric motor
120—Cylinder
121—Piston
122—Combustion chamber
200—Distribution unit

1. A hydrogen gas engine comprising:
a compressor configured to compress the supplied air;
a burner configured to burn the mixed gas of the compressed air by the compressor, and fuel gas;
a driving unit configured to generate power using the expansion force by combustion of the mixed gas in the burner;
a gas generation equipment configured to generate hydrogen gas and oxygen gas by electrolyzing water; and
a fuel gas supplying means configured to connect the gas generation equipment to the burner directly, and to supply the hydrogen gas and oxygen gas to the burner as the fuel gas,
wherein the compression means compresses air with the power generated in the driving unit.

2. The hydrogen gas engine as claimed in claim 1 wherein the driving unit is a turbine which rotates using the expansion force by combustion of the mixed gas.

3. The hydrogen gas engine as claimed in claim 1 wherein the burner and the compressor are combustion chambers formed in a sealed cylinder by the cylinder and this piston that moves up and down in the cylinder, the driving unit is the piston which moves up and down using a expansion force by combustion of the mixed gas.

4. The hydrogen gas engine as claimed in claim 1 wherein the fuel gas supplying means generates a flame using the generating gas from the gas generation equipment, and supplies the flame to the burner.

5. The hydrogen gas engine as claimed in claim 1 wherein the fuel gas supplying means generates a flame by a part of generating gas from the gas generation equipment, the burner mixes the compressed air in the flame and the remaining generating gas, and burns them.

6. The hydrogen gas engine as claimed in claim 1 comprises a photovoltaic power generation unit configured to generate electric power by light-receiving wherein the gas generation equipment takes electric power required for the electrolysis from the photovoltaic power generation unit.

7. The hydrogen gas engine as claimed in claim 1 comprises an aerogenerator configured to generate electric power with wind force wherein the gas generation equipment takes electric power required for the electrolysis from the aerogenerator.

8. The energy-saving automobile running with the power of the hydrogen gas engine as claimed in claim 1.
